(19) United States
(12) Patent Application Publication
(10) Pub. No.: US 2006/0152045 A1
(43) Pub. Date: Jul. 13, 2006

(54) Bicycle seat post

(75) Inventors: Shinpei Okajima, Izumi City (JP); Takeshi Yoshimatsu, Izumi City (JP)

Correspondence Address: GLOBAL IP COUNSELORS, LLP, 1233 20TH STREET, NW, SUITE 700, WASHINGTON, DC, 20036-2680, US

(73) Assignee: Shimano Inc., Sakai (JP)

(21) Appl. No.: 11/030,199

(22) Filed: Jan. 7, 2005

(51) Int. Cl. B62J 1/00

(52) U.S. Cl. 297/195.1

(57) ABSTRACT

A bicycle seat post structure is provided that preferably includes a bicycle seat post member and a bicycle seat attachment assembly. The seat post member includes a substantially linear portion and a bent end portion. The seat attachment assembly is mounted on the bent end portion. Preferably, the bent end portion is arc-shaped and has a substantially uniform, circular transverse external shape. Preferably, the seat attachment assembly includes a lower attachment member, an upper attachment member and a seat attachment structure coupling the upper attachment member to the lower attachment member at a pair of locations. Specifically, a pair of seat clamping elements are preferably coupled to the lower attachment member with a pair of fasteners to clamp a seat portion between the clamping elements and the upper attachment member such that the attachment members are indirectly coupled together when clamped onto the seat post.

### BACKGROUND OF THE INVENTION

1. Field of the Invention

This invention generally relates to a bicycle seat post. More specifically, the present invention relates to a bicycle seat post having a seat post member with a seat attachment assembly adjustably coupled to the bent end portion of the seat post member.

2. Background Information

Bicycling is becoming an increasingly more popular form of recreation as well as a means of transportation. Moreover, bicycling has become a very popular competitive sport for both amateurs and professionals. Whether the bicycle is used for recreation, transportation or competition, the bicycle industry is constantly improving the various components of the bicycle. One component that has been extensively redesigned in recent years is the bicycle seat post.

Generally, bicycles have a frame with a seat post mounted within a seat tube of the frame. The seat post is typically clamped in the seat tube so as to be non-movable relative to the frame. However, the height of the seat post can usually be adjusted by loosening the clamping mechanism of the seat tube of the frame. A bicycle seat is mounted to the upper end of the seat post in an adjustable manner such that the rider can adjust the fore and aft position of the seat relative to the seat post. Additionally, the bicycle seat is mounted to the upper end of the seat post in an adjustable manner such that the rider can adjust the inclination of the seat relative to the seat post. Typically, the seat post has an attachment assembly arranged at the upper end in order to clamp seat rails thereto.

While these prior seat posts work relatively well, they suffer from some deficiencies. In particular, the prior seat posts do not always hold the seat in position as reliably as desired by some riders. Also, with these prior seat posts it can be relatively difficult to adjust the position of the seat relative to the seat post. Moreover, these prior seat posts are not always as strong and lightweight as desired by some riders. Finally, these prior seat posts can be relatively complicated and expensive to manufacture and assemble.

In view of the above, it will be apparent to those skilled in the art from this disclosure that there exists a need for an improved bicycle seat post. This invention addresses this need in the art as well as other needs, which will become apparent to those skilled in the art from this disclosure.

### SUMMARY OF THE INVENTION

One object of the present invention is to provide a bicycle seat post, which reliably supports a bicycle seat in a simple yet adjustable manner.

Another object of the present invention is to provide a bicycle seat post that is relatively strong yet relatively lightweight.

Another object of the present invention is to provide a bicycle seat post that is relatively simple and inexpensive to manufacture and assemble.

The foregoing objects can basically be attained by providing a bicycle seat post that comprises a bicycle seat post member and a bicycle seat attachment assembly. The bicycle seat post member includes a substantially linear portion and an arc-shaped bent end portion extending from the substantially linear portion. The seat post member has a substantially uniform, circular transverse external shape along the arc-shaped bent end portion. The bicycle seat attachment assembly is mounted on the arc-shaped bent end portion of the bicycle seat post member. The bicycle seat attachment assembly is configured to mount a bicycle seat thereto.

The foregoing objects can also basically be attained by providing a bicycle seat post structure that comprises a bicycle seat attachment assembly. The bicycle seat attachment assembly is configured to be clamped on a bent end portion of a bicycle seat post member. The bicycle seat attachment assembly includes a lower attachment member, an upper attachment member and a seat attachment structure. The upper attachment member is coupled to the lower attachment member by a pair of fasteners with a bent end portion receiving area located between the upper and lower attachment members. The seat attachment structure includes a pair of seat clamping elements coupled to the lower clamping member via the fasteners in order to clamp a portion of a bicycle seat between the seat clamping elements and the upper attachment member such that the upper attachment member and the lower attachment member are indirectly coupled together when clamped onto the bent end portion.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a side elevational view of a bicycle equipped with a bicycle seat post supporting a bicycle seat in accordance with the present invention;

FIG. 2 is an enlarged rear perspective view of the bicycle seat post supporting the bicycle seat illustrated in FIG. 1, with the majority of the seat removed for the purpose of illustration;

FIG. 3 is a side elevational view of the bicycle seat post illustrated in FIG. 2, with the seat removed and the seat post removed from the bicycle frame for the purpose of illustration;

FIG. 4 is a cross-sectional view of the bicycle seat post illustrated in FIGS. 2 and 3, as seen along section line 4-4 of FIG. 3 prior to clamping the seat rails thereto;

FIG. 5 is a cross-sectional view of the bicycle seat post illustrated in FIGS. 2 and 3, as seen along section line 4-4 of FIG. 3 after clamping the seat rails thereto;

FIG. 6 is a rear elevational view of the bicycle seat post illustrated in FIGS. 2-5, with the seat removed for the purpose of illustration;

FIG. 7 is a cross-sectional view of the bicycle seat post illustrated in FIGS. 2-6, as seen along section line 7-7 of FIG. 6;

FIG. 8 is an upper perspective view of the upper attachment member of the bicycle seat attachment assembly of the bicycle seat post illustrated in FIGS. 2-7;

FIG. 9 is a top plan view of the upper attachment member illustrated in FIG. 8;

FIG. 10 is an end elevational view of the upper attachment member illustrated in FIGS. 8 and 9;

FIG. 11 is a side elevational view of the upper attachment member illustrated in FIGS. 8-10;

FIG. 12 is a cross-sectional view of the upper attachment member illustrated in FIGS. 8-11, as seen along section line 12-12 of FIG. 10;

FIG. 13 is an upper perspective view of the lower attachment member of the bicycle seat attachment assembly of the bicycle seat post illustrated in FIGS. 2-7;

FIG. 14 is an lower perspective view of the lower attachment member illustrated in FIG. 13;

FIG. 15 is an end elevational view of the lower attachment member illustrated in FIGS. 13 and 14;

FIG. 16 is a side elevational view of the lower attachment member illustrated in FIGS. 13-15;

FIG. 17 is a bottom plan view of the lower attachment member illustrated in FIGS. 13-16;

FIG. 18 is a cross-sectional view of the lower attachment member illustrated in FIGS. 13-17, as seen along section line 18-18 of FIG. 17;

FIG. 19 is a cross-sectional view of the lower attachment member illustrated in FIGS. 13-17, as seen along section line 19-19 of FIG. 15;

FIG. 20 is a lower perspective view of one of the seat rail attachment elements of the bicycle seat attachment assembly of the bicycle seat post illustrated in FIGS. 2-7;

FIG. 21 is a bottom plan view of the seat rail attachment element illustrated in FIG. 20;

FIG. 22 is an inside elevational view of the seat rail attachment element illustrated in FIGS. 20 and 21;

FIG. 23 is an end elevational view of the seat rail attachment element illustrated in FIGS. 20-22;

FIG. 24 is an outside elevational view of the seat rail attachment element illustrated in FIGS. 20-23; and

FIG. 25 is a cross-sectional view of the seat rail attachment element illustrated in FIGS. 20-24, as seen along section line 25-25 of FIG. 21.

### DETAILED DESCRIPTION OF THE PREFERRED EMBODIMENTS

A selected embodiment of the present invention will now be explained with reference to the drawings. It will be apparent to those skilled in the art from this disclosure that the following descriptions of the embodiment of the present invention are provided for illustration only and not for the purpose of limiting the invention as defined by the appended claims and their equivalents.

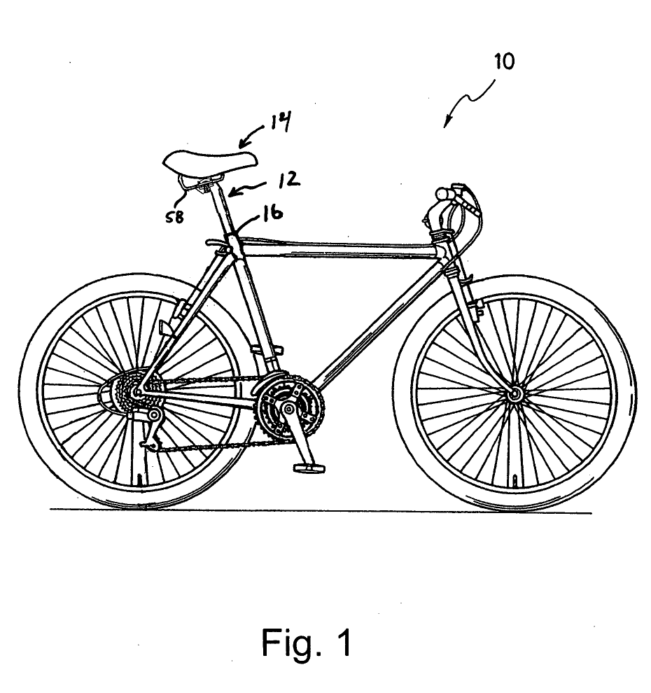

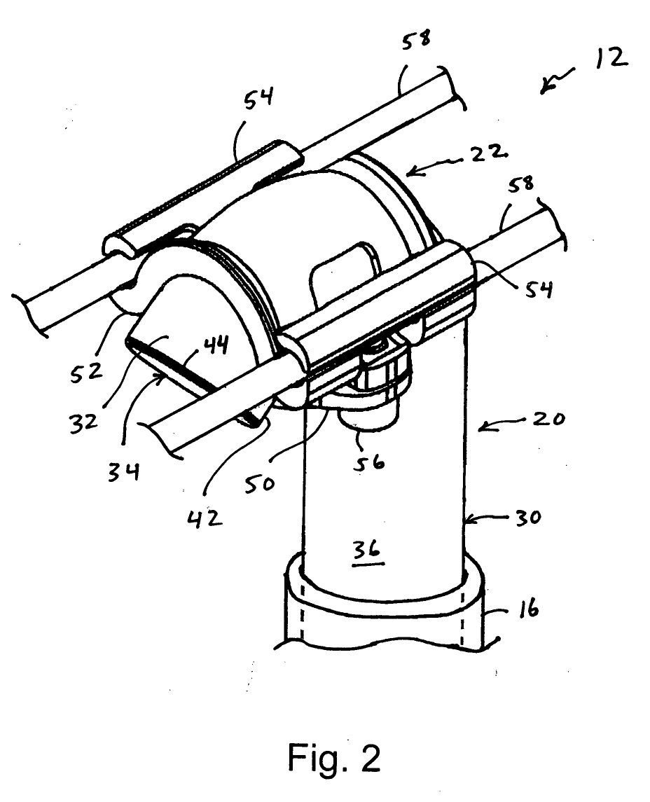

Referring initially to FIGS. 1 and 2, a bicycle 10 with a bicycle seat post 12 supporting a bicycle seat 14 is illustrated in accordance with a preferred embodiment of the present invention. Specifically, the bicycle seat post 12 has a bent configuration (i.e. a substantially J-shaped configuration) with the bicycle seat 14 mounted thereto in accordance with the present invention, as explained below. The bicycle 10 is conventional, except for the bicycle seat post 12 supporting the bicycle seat 14. Accordingly, the bicycle 10 will not be discussed and/or illustrated in detail herein, except as related to the present invention.

In this embodiment, the bicycle seat post 12 is preferably mounted in a seat tube 16 of the frame of the bicycle 10 in a conventional manner. Specifically, the seat post 12 is preferably clamped in the seat tube 16 with a releasable clamping mechanism (not shown) in a conventional manner such that the seat post 12 is normally non-movable relative to the seat tube 16 yet longitudinally adjustable relative to the seat tube 16 upon releasing the clamping mechanism (not shown). Of course, it will be apparent to those skilled in the bicycle art from this disclosure that the seat post 12 of the present invention can be mounted to the frame in various other ways, as needed and/or desired.

The bicycle seat post 12 of the present invention basically includes a bicycle seat post member 20 and a bicycle seat attachment assembly 22 coupled to the seat post member 20 in accordance with the present invention. Specifically, the seat post member 20 basically has a bent pipe configuration with the seat attachment assembly mounted at the bent area. More specifically, the seat post member 20 basically includes a substantially linear portion 30, a bent end portion 32 and an end cap 34. The bent end portion 32 is preferably arc-shaped with a substantially uniform, circular transverse external shape. In the illustrated embodiment, the substantially linear portion 30 has a linear configuration. However, it will be apparent to those skilled in the bicycle art that the shape of the portion 30 can be modified slightly as needed and/or desired. In any case, the shape of the portion 30 is preferably substantially linear. The seat attachment assembly 22 is clamped onto the arc-shaped bent end portion 32 in an adjustable manner at two laterally spaced fastening locations in accordance with the present invention, as explained below in more detail.

Referring now to FIGS. 1-7, the seat post member 20 will now be explained in more detail. The linear portion 30 of the seat post member 20 is preferably partially received in the seat tube 16 in a conventional manner. Preferably, the bent end portion 32 has an arc-shape as mentioned above. In particular, the bent end portion 32 has an arc-shape as viewed in side elevation when the seat post member 20 is mounted in its normal riding position in the seat tube 16. Due to this arc-shaped configuration of the bent end portion 32 and the inclination the seat attachment assembly 22, and thus, the inclination of the seat 14 can be adjusted relative to the seat post member 20 by varying the mounting location of the seat attachment assembly 22 on the bent end portion 32, as explained below. The longitudinal position of the seat 14 relative to the seat post member 20 is also slightly adjusted when the inclination of the seat attachment assembly 22 is adjusted. However, the longitudinal position of the seat 14 relative to the seat post member 20 is primarily adjusted by adjusting the longitudinal position of the seat 14 relative to the seat attachment assembly 22 when the seat attachment assembly 22 is loosened, as also explained below.

The substantially linear portion 30 and the bent end portion 32 are preferably integrally formed together as a one-piece, unitary tubular member with a longitudinal hollow area A extending therethrough. The longitudinal hollow area A preferably has a substantially J-shaped configuration with a circular cross-sectional profile. A substantially J-shaped longitudinal center axis X of the seat post member 20 is centrally located within the longitudinal hollow area A. The substantially linear portion 30 and the bent end portion 32 are constructed of a lightweight rigid material. Specifically, the substantially linear portion 30 and the bent end portion 32 are preferably constructed of a carbon fiber composite material and/or a metallic material (e.g. aluminum alloy) using conventional manufacturing techniques that are well known in the bicycle art. Due to the simple shape of the seat post member 20 (i.e. the linear portion 30 and the bent end portion 32), it is relatively simple and inexpensive to construct these parts of a carbon fiber composite material and/or a metallic material (e.g. aluminum alloy) using conventional manufacturing techniques that are well known in the bicycle art.

In any case, the substantially linear portion 30 is preferably contiguously connected to the bent end portion 32 in a smooth manner. In other words, the substantially linear portion 30 extends tangentially relative to the arc-shaped bent end portion 32. Thus, the seat post member 20 preferably has a contiguous exterior surface 36 and a contiguous interior surface 38 extending along both the substantially linear portion 30 and the bent end portion 32. The substantially linear portion 30 has a first free end 40 of the seat post member 20, while the bent end portion 32 has a second free end 42 of the seat post member 20. The exterior and interior surfaces 36 and 38 extend between the first and second free ends 40 and 42.

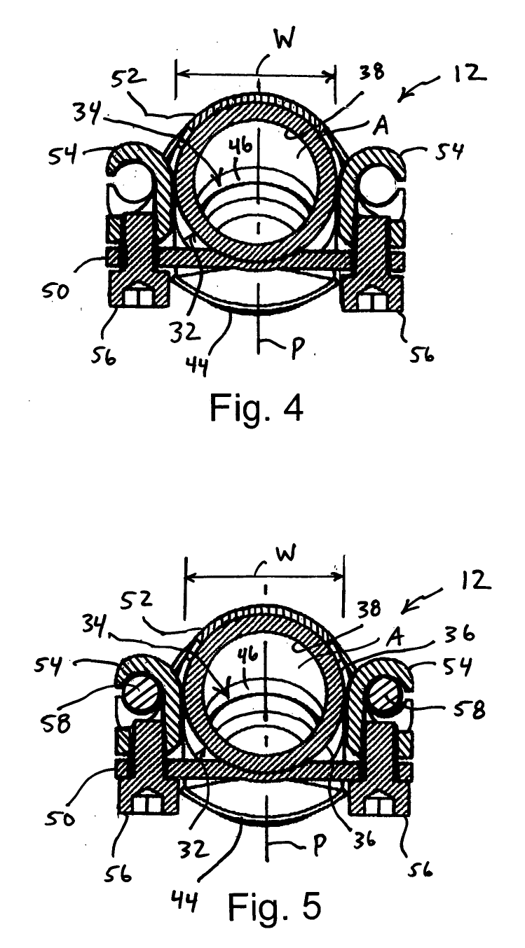

The exterior surface 36 preferably has a substantially uniform, circular cross-sectional profile along the entire seat post member 20. Similarly, the interior surface 38 preferably has a substantially uniform, circular cross-sectional profile along the entire seat post member 20, except at the location of the end cap 34. Thus, the seat post member 20 preferably has a substantially uniform wall thickness along the entire length of the seat post member 20, except at the location of the end cap 34. In any case, the seat post member 20 preferably has a substantially uniform, circular transverse external shape along at least the arc-shaped bent end portion 32. Thus, in this embodiment the bent end portion 32 has a maximum external transverse width W that corresponds to the external diameter of the bent end portion 32, as best seen in FIGS. 4 and 5.

Of course, it will be apparent to those skilled in the bicycle art from this disclosure that various modifications can be made to the substantially linear portion 30 and/or the bent end portion 32 without departing from the scope of the present invention. In any case, the external surface 36 at the bent end portion 32 preferably has a smooth, contiguous (i.e. contoured) external shape defining a majority of the substantially uniform, circular transverse external shape of the seat post member 20 along the arc-shaped bent end portion 32. Also, the seat attachment assembly 22 has a mating structure/shape so as to be mounted on the external surface 36 at the bent end portion 32 in accordance with the present invention. The seat post member 20 (i.e. the linear portion 30 and the bent end portion 32) is preferably free of any openings formed therein, except for the longitudinal hollow area A extending therethrough.

The end cap 34 is preferably mounted at the second free end 42 of the bent end portion 32 to enclose one end of the longitudinal hollow area A. The end cap 34 provides an aesthetically pleasing appearance at the second free end 42. The end cap 34 also prevents debris such as water or mud from entering the seat post member 20, and thus, entering the seat tube 16 of the frame of the bicycle 10. Finally, the end cap 34 is preferably a rigid member that provides some reinforcement for the bent end portion 32 at the second free end 42. The end cap 34 includes an end cap section 44 and a tubular support section 46 extending from the end cap section 44 to form a substantially cup-shaped element.

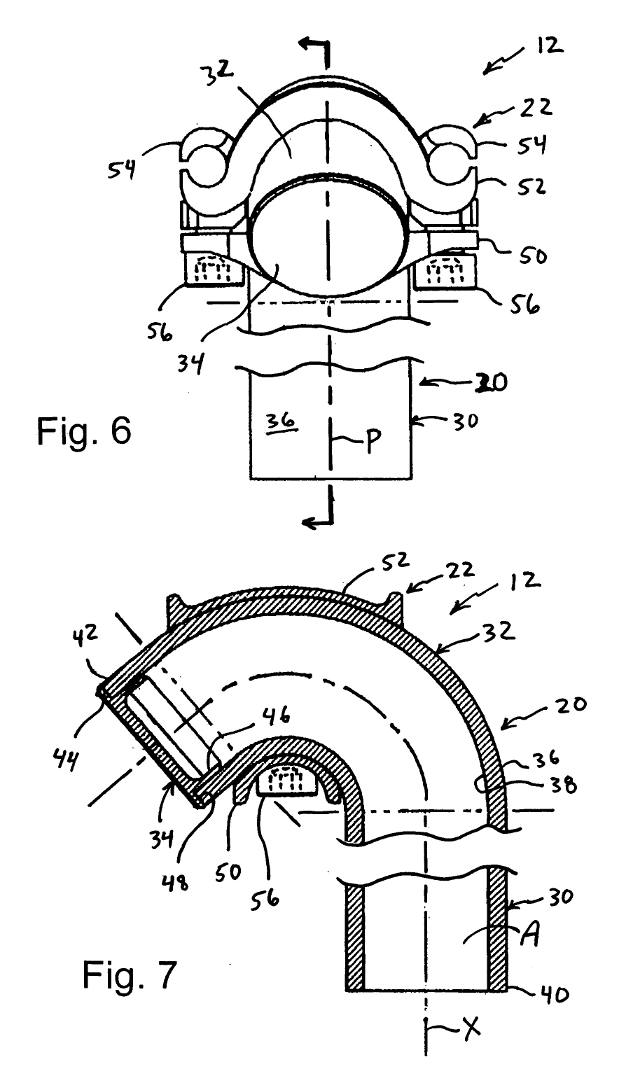

The support section 46 extends into the hollow area A and contacts the interior surface 38 at the second free end 42 of the bent end section 32. The end cap section 44 has a shape corresponding to the shape of the external surface 36 at the second free end 42. Thus, the end cap section 44 preferably has a circular, disc-shaped configuration. The support section 46 has a shape corresponding to the internal shape of the internal surface 38 at the second free end 42. Thus, the support section 46 preferably has a circular, tubular shape, as best seen in FIGS. 6 and 7. The support section 46 preferably contacts the interior surface 38 around the entire periphery of the support section 46. The support section 46 is preferably frictionally retained within the hollow area A at the second free end 42 of the bent end portion 32. The support section 46 has a smaller maximum diameter than the end cap section 44 to form an annular ledge 48, which contacts the axial face of the second free end 42.

The end cap 34 is preferably constructed as a one-piece unitary member from a lightweight, rigid material such as a metallic material (e.g. aluminum alloy) using manufacturing techniques that are well known in the bicycle art such as casting and/or machining. In this embodiment, the end cap is symmetrical about the longitudinal center axis X when mounted at the second free end 42. In any case, the end cap 34 preferably has a size and shape corresponding to the configuration of the second free end 42 of the bent end portion 32.

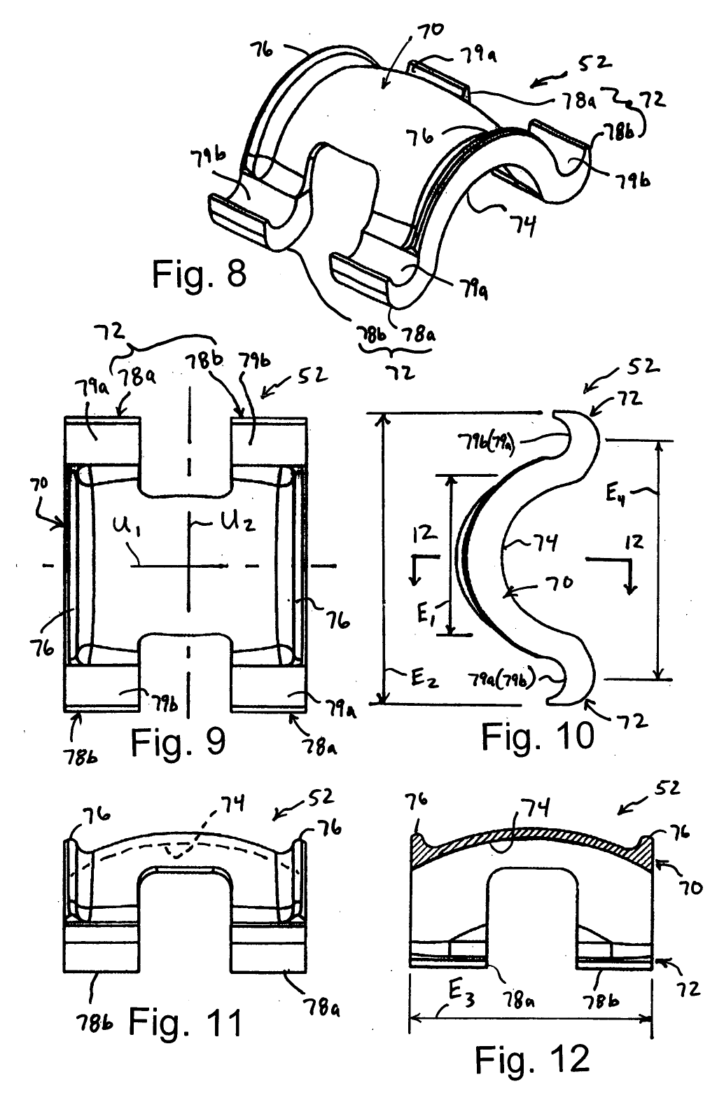

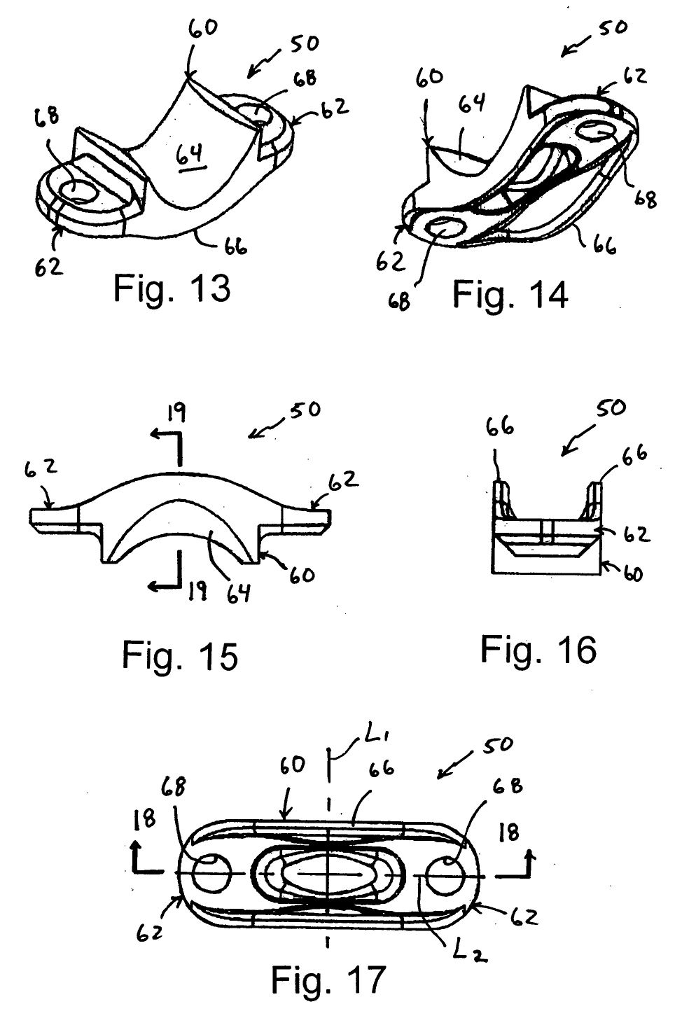

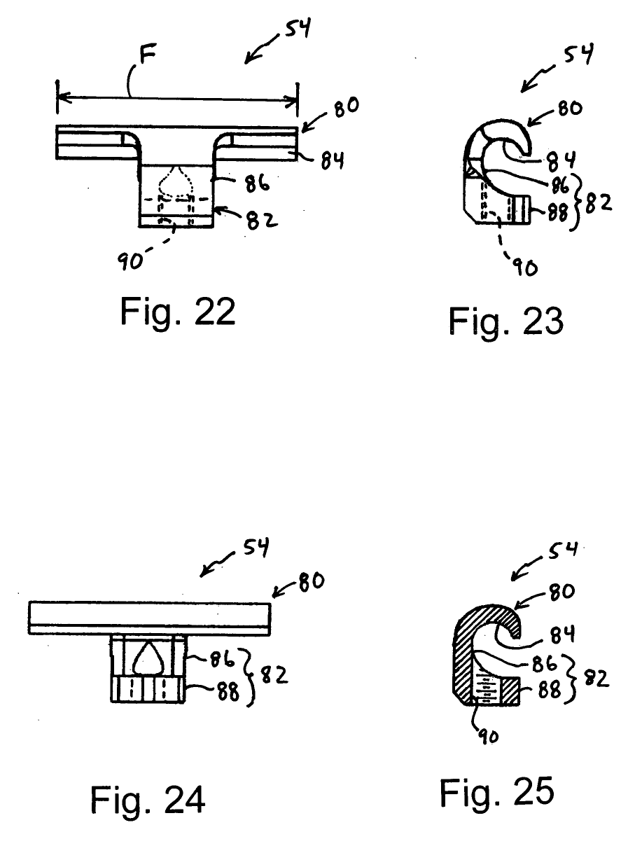

Referring now to FIGS. 1-25, the seat attachment assembly 22 will now be explained in more detail. The seat attachment assembly 22 basically includes a lower attachment member 50, an upper attachment member 52, a pair of identical seat clamping elements 54 and a pair of identical fasteners 56. The lower attachment member 50 and the upper attachment member 52 are preferably indirectly clamped onto the bent end portion 32 via the seat clamping elements 54 a portion of the seat 14 and the fasteners 56. Specifically, the fasteners 56 extend through the lower attachment member 50 and are coupled to the seat clamping elements 54. Preferably, the fasteners 56 are threadedly coupled to the seat clamping elements 54 to move the seat clamping elements 54 upon rotating the fasteners 56. The fasteners 56 are preferably conventional bolts, each having a threaded shaft and enlarged head with a hexagonal opening.

More specifically, the seat 14 includes a pair of seat rails 58 that are clamped between the upper attachment member 52 and the seat clamping elements 54 when the fasteners 56 are rotated to move the seat clamping elements 54 toward the upper attachment member 52. When the seat rails 58 are securely clamped between the upper attachment member 52 and the seat clamping elements 54 by rotating the fasteners 56, the lower attachment member 50 and the upper attachment member 52 will also be moved toward each other upon continuing to rotate the fasteners to indirectly clamp the lower and upper attachment members 50 and 52 together onto the bent end portion 32. Upon rotating the fasteners 56 in the opposite direction, the structure is loosened to allow adjustment and/or removal of the seat 14. Assembly, adjustment and disassembly of the seat attachment assembly 22 will be explained in more detail below.

The seat rails 58 form parts of an attachment portion of the seat 14 in a conventional manner. In other words, the seat 14 is conventional except the manner in which it is attached to the seat post 12 of the present invention. Accordingly, the seat 14 will not be discussed and/or illustrated in further detail herein, except as related to the present invention. Rather it will be apparent to those skilled in the bicycle art from this disclosure that any seat with conventional parallel seat rails configured as disclosed herein can be used in conjunction with the present invention. Moreover, it will be apparent to those skilled in the bicycle art from this disclosure that the present invention can be modified as needed and/or desired to be used with other types of bicycle seats.

Referring to FIGS. 2-7 and 13-19, the lower attachment member 50 will now be discussed in more detail. The lower attachment member 50 basically includes a lower clamping portion 60 and a pair of lower attachment portions 62 extending from opposite lateral sides of the lower clamping portion 60. The lower clamping portion 60 and the lower attachment portions 62 are preferably integrally formed together as a one-piece unitary member from a lightweight rigid material such as a metallic material (e.g. aluminum alloy) by casting, machining or any other suitable manufacturing technique that is known in the bicycle art.

The lower attachment member 50 is preferably symmetrical relative to a longitudinal center plane L₁ and a transverse center plane L₂ perpendicular to the longitudinal center plane L₁. The longitudinal center plane L₁ is preferably coincident with a longitudinal center plane P of the seat post member 20 when the seat attachment assembly 22 is mounted thereto. The longitudinal center axis X lies in the longitudinal center plane P, while the longitudinal center plane P preferably coincides with the overall longitudinal center plane (not shown) of the bicycle 10 when the seat post 12 is mounted in its normal riding position.

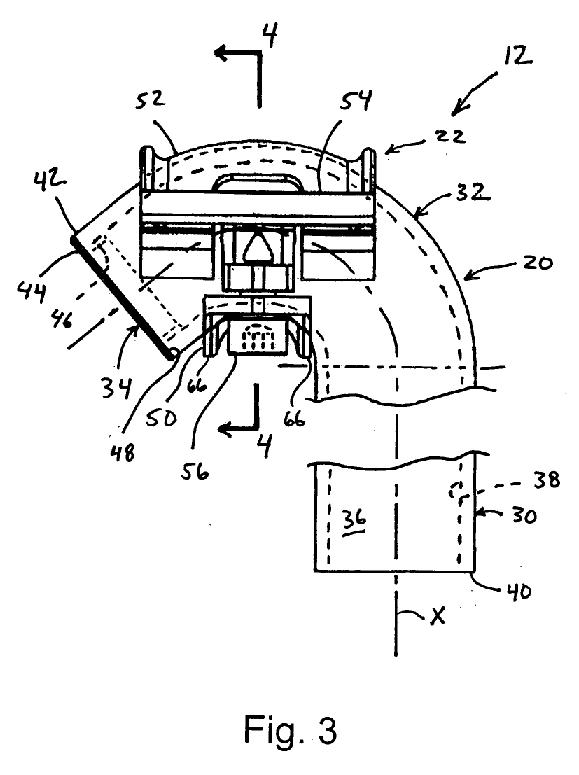

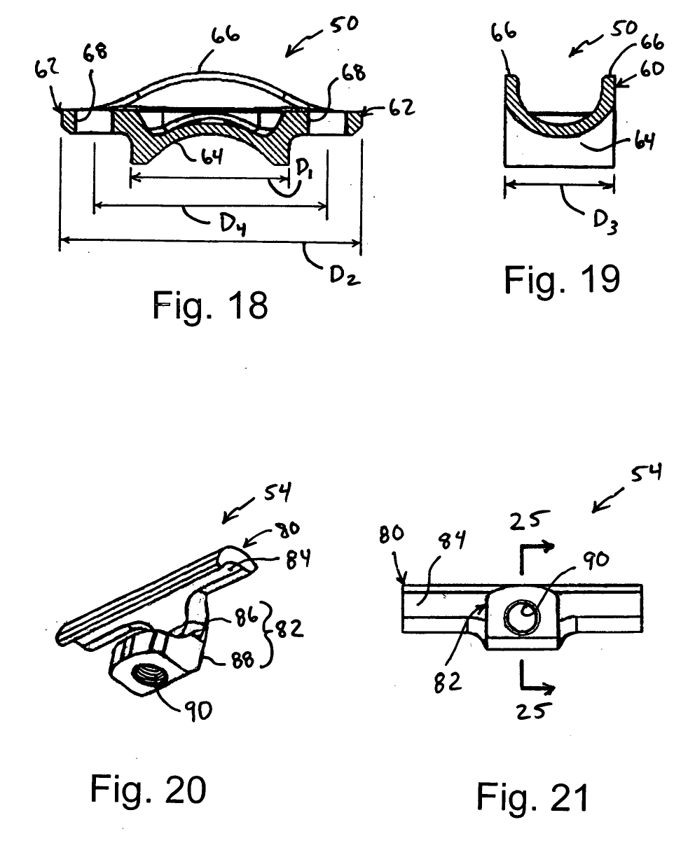

The lower clamping portion 60 includes a curved lower clamping surface 64 sized and configured to contact the exterior surface 36 of the seat post member 20 at the bent end portion 32. In particular, the lower clamping surface 64 has a concave shape as viewed in transverse cross-section (FIG. 18) and a convex shape as viewed in longitudinal cross-section (FIG. 19) so as to contact the exterior surface 36 in the internal elbow area of the arc-shaped bent end portion 32 (i.e. the radially inward side of the arc-shaped bent end portion 32), as best seen in FIGS. 3 and 7. A pair of reinforcing flanges 66 extend transversely along the lower clamping portion 60 and the lower attachment portions 62. The lower clamping portion 60 has a maximum transverse dimension D₁. The lower clamping member 50 has a maximum overall transverse dimension D₂, a maximum longitudinal dimension D₃ as well as a clamping dimension D₄. The lower clamping surface 64 of the lower clamping portion 60 extends longitudinally along the entire maximum longitudinal dimension D₃.

The maximum transverse dimension D₁ of the lower clamping portion 60 is preferably substantially equal to the maximum external transverse width W of the bent end portion 32. In any case, the maximum transverse dimension D₁ is preferably substantially larger than one-half of the maximum external transverse width W. The lower clamping surface 64 extends substantially along the entire maximum transverse dimension D₁ of the lower clamping portion 60, as best seen in FIGS. 15 and 18. Thus, the maximum transverse width of the lower clamping surface 64 is preferably substantially equal (i.e. only slightly smaller) to the maximum external transverse width W of the bent end portion 32. In any case, the maximum transverse width of the lower clamping surface 64 is preferably substantially larger than one-half of the maximum external transverse width W. The maximum longitudinal dimension D₃ is also preferably substantially larger than one-half of the maximum external transverse width W. In any case, the maximum longitudinal dimension D₃ is preferably at least one-half of the maximum external transverse width W.

Each of the lower attachment portions 62 includes an unthreaded through hole 68 sized and configured to receive the shaft of one of the fasteners 56 therethrough. The clamping dimension D₄ is measured laterally between the centers of the through holes 68, and thus, between the centers of the fasteners 56 when the seat attachment assembly 22 is mounted on the seat post member 20. The clamping dimension D₄ is substantially larger than the maximum transverse dimension D₁ of the lower clamping portion 60 (i.e. at least about 25% larger). Thus, the clamping dimension D₄ is preferably substantially larger than the transverse width W (i.e. at least about 25% larger). Accordingly, the clamping locations of the seat attachment assembly 22 are laterally spaced on opposite sides of the seat post member 20.

Referring to FIGS. 2-12, the upper attachment member 52 will now be discussed in more detail. The upper attachment member 52 has a substantially C-shaped configuration, as viewed longitudinally. The upper attachment member 52 basically includes an upper clamping portion 70 and a pair of upper attachment portions 72 extending from opposite lateral sides of the upper clamping portion 70. The upper clamping portion 70 and the upper attachment portions 72 are preferably integrally formed together as a one-piece unitary member from a lightweight rigid material such as a metallic material (e.g. aluminum alloy) by casting, machining or any other suitable manufacturing technique that is known in the bicycle art. The upper attachment member 52 is preferably symmetrical relative to a longitudinal center plane U₁ and a transverse center plane U₂ perpendicular to the plane U₁. The longitudinal center plane U₁ is preferably coincident with the longitudinal center plane P of the seat post member 20 when the seat attachment assembly 22 is mounted to the seat post member 20.

The upper clamping portion 70 includes a curved upper clamping surface 74 sized and configured to contact the exterior surface 36 of the seat post member 20 at the bent end portion 32. In particular, the upper clamping surface 74 has a concave shape as viewed in transverse cross-section (FIGS. 4, 5 and 10) and a concave shape as viewed in longitudinal cross-section (FIG. 12) so as to contact the exterior surface 36 in the external elbow area of the arc-shaped bent end portion 32 (i.e. the radially outward side of the arc-shaped bent end portion 32), as best seen in FIGS. 3 and 7. A pair of reinforcing flanges 76 extend transversely along the upper clamping portion 70. The upper clamping surface 74 of the upper clamping portion 70 has a maximum transverse dimension E₁. The upper clamping member 52 has a maximum overall transverse dimension E₂, a maximum longitudinal dimension E₃ as well as a clamping dimension E₄. The upper clamping surface 74 of the upper clamping portion 70 extends longitudinally along the entire maximum longitudinal dimension E₃.

Preferably, the dimensions E₁, E₂ and E₄ are substantially identical to the dimensions D₁, D₂ and D₄, respectively. However, the dimension E₃ is substantially larger than the dimension D₃ (i.e. at least twice as large). In any case, the descriptions of the preferred dimensional relationships of the dimensions D₁, D₂, D₃ and D₄ relative to the maximum transverse width W of the seat post member 20 also apply to the dimensions E₁, E₂, E₃ and E₄, except as explained and illustrated herein.

Each of the upper attachment portions 72 includes a pair of longitudinally arranged attachment sections 78a and 78b with a space formed therebetween. The seat clamping elements 54 are sized and configured to be partially received in the spaces between the pairs attachment sections 78a and 78b. Each of the attachment sections 78a includes a curved seat clamping surface 79a, while each of the attachment section 78b includes a curved seat clamping surface 79b. The seat clamping surfaces 79a and 79b extend longitudinally along the entirety of the clamping sections 78a and 78b, respectively. Each pair of clamping surfaces 79a and 79b forms a seat rail support surface on each lateral side of the upper attachment member 52.

The seat clamping surfaces 79a and 79b are sized and configured to contact the seat rails 58 to clamp the seat rails 58 between the attachment sections 78a and 78b and the seat clamping elements 54. Each of the attachment sections 78a and 78b preferably has a longitudinal dimension that is about one third of the maximum longitudinal dimension E₃. Thus, each set of one of the clamping surfaces 79a and one of the clamping surfaces 79b located on each lateral side of the seat post member 20 extends along more than half of the maximum longitudinal dimension E₃.

Referring to FIGS. 2-7 and 20-25, the seat clamping elements 54 will now be discussed in more detail. Each of the seat clamping elements 54 basically includes a seat clamping portion 80 and a coupling portion 82 extending from the seat clamping portion 80. The seat clamping portion 80 and the coupling portion 82 of each seat clamping element 54 are preferably integrally formed together as a one-piece unitary member from a lightweight rigid material such as a metallic material (e.g. aluminum alloy) by casting, machining or any other suitable manufacturing technique that is known in the bicycle art.

Each seat clamping portion 80 has a substantially C-shaped configuration, as viewed longitudinally, while each of the coupling portions 82 has a substantially L-shaped configuration as viewed longitudinally. Each seat clamping portion 80 includes a seat clamping surface 84 sized and configured to contact the seat rails 58 to clamp the seat rails 58 between the attachment sections 78a and 78b and the seat clamping surface 84. Each of the coupling portions 82 includes a connecting section 86 and coupling section 88 with a threaded through bore 90 formed therein. The connecting sections 86 extend between the seat clamping portions 80 and the coupling sections 88. The coupling sections 88 are substantially perpendicular to the connecting sections 86 such that each of the seat clamping elements 54 has an overall C-shape as viewed longitudinally.

The coupling portions 82 are preferably slightly narrower than the spaces formed between each set of one of the clamping sections 78a and one of the clamping sections 78b located on each lateral side of the seat post member 20 to be received in the spaces therebetween. The seat clamping surfaces 84 are opposed to each set of one of the clamping surfaces 79a and one of the clamping surfaces 79b located on each lateral side of the seat post member 20 to form a pair of seat rail receiving spaces located on opposite later sides of the seat post member 20, as best seen in FIG. 4, in order to clamp the seat rails 58 therebetween as best seen in FIG. 5. Thus, the seat clamping elements 54 are preferably seat rail clamping elements. Each of the clamping portions 80 has a maximum longitudinal dimension F that is substantially equal to the maximum longitudinal dimension E₃ of the upper clamping member 50. Accordingly, a relatively large seat clamping structure is formed to securely attach the seat 14 to the seat attachment assembly 22.

Each threaded bore 90 is arranged to be aligned with one of the through holes 68 of the lower attachment member to threadedly receive one the fasteners 56 therein. The threaded bores 90, the through holes 68 and the fasteners 56 are substantially aligned with the seat rails 58 when the seat attachment assembly 22 is assembled. In other words, the lower and upper attachment members 50 and 52 are not directly coupled together, but indirectly via the seat clamping elements 54, the seat rails 58 and the fasteners 56. The centers of the fasteners 56 are preferably at least partially laterally aligned with the seat rails 58 (in the illustrated embodiment substantially aligned, as seen in FIG. 5). In other words, the fasteners 56 preferably are not located laterally inwardly of the seat rails 58. Of course, the seat rails 58 correspond in size and location to the seat rail receiving spaces formed between the upper attachment member 52 and the seat clamping elements 54.

Referring again to FIGS. 1-7, assembly, adjustment and disassembly of the seat post 12 and the seat 14 will now be discussed in more detail. The upper attachment member 52 is positioned on the lower attachment member 50, and the seat attachment elements 54 are positioned with their coupling portions 82 between the sets of one of the clamping sections 78a and one of the clamping sections 78b located on the lateral sides of the seat post member 20. The fasteners 56 are then inserted through the through holes 68 of the lower attachment member 50 and partially threaded into the threaded through bores 90 of the coupling portions 82. The seat rails 58 are positioned below the clamping portions 80 of the seat clamping elements 54 above the clamping sections 78a and 78b of the upper attachment member 52. The seat rails 58 can be positioned before or after threading the fasteners 56 into the threaded through bores 90.

The above steps can be performed with the parts totally removed from the seat post member 20, or with the bent end portion 32 arranged between the lower attachment member 50 and the upper attachment member 52. In other words, when the fasteners 56 are only partially tightened, the seat attachment assembly is slidable on the seat post member 20. In any case, once the seat attachment assembly 22 with the partially tightened fasteners 56 and the properly positioned seat rails 58 is positioned on the bent end port 32 of the seat post member 20, the fasteners 56 are then tightened to non-movably clamp the seat rails 56 between the upper attachment member 52 and the seat clamping elements 54 and to non-movably clamp the seat post member 20 between the lower attachment member 50 and the upper attachment member 52. The desired seat position (i.e. both longitudinal position as well as inclination) should be adjusted prior to tightening the fasteners 56.

However, if the seat position needs to be adjusted later, the rider must simply loosen the fasteners 56 sufficiently. In other words, to adjust the longitudinal position of the seat 14 relative to the seat attachment assembly 22 and/or to adjust the inclination of the seat 14 relative to the seat post member 20, the fasteners 56 simply need to be loosened. The seat 14 can then be moved into the desired position, and the fasteners 56 retightened. With the arrangement of the present invention, the seat position is adjusted in a relatively simple manner by loosening the fasteners 56, yet the seat 14 is securely held in position when the fasteners 56 are tightened. Of course, the seat post 12 can be mounted in the seat tube 16 with the clamping mechanism (not shown) before or after assembly. The seat post 12 of the present invention is disassembled/removed from the bicycle 12 by following the above directions for assembly in reverse order, and by loosening the clamping mechanism (not shown) of the seat tube 16.

As used herein to describe the present invention, the following directional terms “forward, rearward, above, downward, vertical, horizontal, below and transverse” as well as any other similar directional terms refer to those directions of a bicycle equipped with the present invention. Accordingly, these terms, as utilized to describe the present invention should be interpreted relative to a bicycle equipped with the present invention.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A bicycle seat post comprising:
a bicycle seat post member including a substantially linear portion and an arc-shaped bent end portion extending from the substantially linear portion, the seat post member having a substantially uniform, circular transverse external shape along the arc-shaped bent end portion; and
a bicycle seat attachment assembly mounted on the arc-shaped bent end portion of the bicycle seat post member, the bicycle seat attachment assembly being configured to mount a bicycle seat thereto.

2. The bicycle seat post according to claim 1, wherein
the substantially linear mounting portion and the arc-shaped bent end portion are integrally formed together as a one-piece, unitary member.

3. The bicycle seat post according to claim 2, wherein
the bicycle seat post member includes a longitudinal hollow area extending therethrough.

4. The bicycle seat post according to claim 1, wherein
the bicycle seat post member includes a longitudinal hollow area extending therethrough.

5. The bicycle seat post according to claim 4, wherein
the bicycle seat post member is free of any openings formed therein, except for the longitudinal hollow area extending therethrough.

6. The bicycle seat post according to claim 4, wherein
the bicycle seat post member includes an end cap attached to a free end of the arc-shaped bent end portion.

7. The bicycle seat post according to claim 1, wherein
the seat post member has a substantially uniform, circular transverse external shape along the arc-shaped bent end portion and the substantially linear portion.

8. The bicycle seat post according to claim 1, wherein
the seat post member has a smooth, contiguous external surface defining a majority of the substantially uniform, circular transverse external shape along the arc-shaped bent end portion.

9. The bicycle seat post according to claim 8, wherein
the bicycle seat attachment assembly includes a lower attachment member, an upper attachment member and a seat attachment structure, and
the upper attachment member is coupled to the lower attachment member by at least one fastener with the arc-shaped bent end portion located between the upper and lower attachment members.

10. The bicycle seat post according to claim 9, wherein
the lower attachment member is located on a radially inward side of the arc-shaped bent end portion and the upper attachment member is located on a radially outward side of the arc-shaped bent end portion such that the upper and lower attachment members can be clamped onto the arc-shaped bent end portion with the at least one fastener.

11. The bicycle seat post according to claim 10, wherein
the upper attachment member is coupled to the lower attachment member with a pair of fasteners located on opposite lateral sides of a longitudinal center plane of the bicycle seat post member.

12. The bicycle seat post according to claim 11, wherein
the upper attachment member includes an upper curved surface that contacts external surface of the bent end portion when clamped onto the arc-shaped bent end portion, and
the lower attachment member includes a lower curved surface that contacts the external surface of the bent end portion when clamped onto the arc-shaped bent end portion.

13. The bicycle seat post according to claim 11, wherein
the seat attachment structure includes a pair of seat rail clamping elements coupled to the lower clamping member via the fasteners in order to clamp a pair of seat rails of the bicycle seat between the seat rail clamping elements and the upper attachment member such that the upper attachment member and the lower attachment member are indirectly coupled together when clamped onto the arc-shaped bent end portion.

14. The bicycle seat post according to claim 13, wherein
the upper attachment member includes a pair of laterally spaced rail support surfaces and the seat rail clamping elements include rail clamping surfaces opposed to the rail support surfaces to form a pair of laterally spaced seat rail receiving spaces between the upper attachment member and the seat clamping elements, and
the fasteners are not located laterally inwardly of the seat rail receiving spaces relative to the longitudinal center plane.

15. The bicycle seat post according to claim 14, wherein
the fasteners are substantially laterally aligned with the seat rail receiving spaces relative to the longitudinal center plane.

16. The bicycle seat post according to claim 10, wherein
the seat attachment structure includes at least one seat clamping element coupled to the lower clamping member via the at least one fastener in order to clamp a portion of the bicycle seat between the at least one seat clamping element and the upper attachment member such that the upper attachment member and the lower attachment member are indirectly coupled together when clamped onto the arc-shaped bent end portion.

17. A bicycle seat post structure comprising:
a bicycle seat attachment assembly configured to be clamped on a bent end portion of a bicycle seat post member, the bicycle seat attachment assembly including a lower attachment member, an upper attachment member and a seat attachment structure,
the upper attachment member being coupled to the lower attachment member by a pair of fasteners with a bent end portion receiving area located between the upper and lower attachment members,
the seat attachment structure including a pair of seat clamping elements coupled to the lower clamping member via the fasteners in order to clamp a portion of a bicycle seat between the seat clamping elements and the upper attachment member such that the upper attachment member and the lower attachment member are indirectly coupled together when clamped onto the bent end portion.

18. The bicycle seat post structure according to claim 17, further comprising
a bicycle seat post member that includes a substantially linear portion and a bent end portion extending from the substantially linear portion.

19. The bicycle seat post structure according to claim 18, wherein
the bicycle seat post member is a tubular member that includes a longitudinal hollow area extending therethrough.

20. The bicycle seat post structure according to claim 19, wherein
the bicycle seat post member is free of any openings formed therein, except for the longitudinal hollow area extending therethrough.

21. The bicycle seat post structure according to claim 17, wherein
the upper attachment member includes a pair of laterally spaced rail support surfaces and the seat clamping elements include rail clamping surfaces opposed to the rail support surfaces to form a pair of laterally spaced seat rail receiving spaces between the upper attachment member and the seat clamping elements, and
the fasteners are not located laterally inwardly of the seat rail receiving spaces relative to a longitudinal center plane of the bent end portion receiving area.

22. The bicycle seat post structure according to claim 21, wherein
the fasteners are substantially laterally aligned with the seat rail receiving spaces relative to the longitudinal center plane.
